(19) United States
(12) Patent Application Publication
(10) Pub. No.: US 2026/0057244 A1
(43) Pub. Date: Feb. 26, 2026

(54) DECENTRALIZED LEARNING BASED ON ACTIVATION FUNCTION

(71) Applicant: Telefonaktiebolaget LM Ericsson (publ), Stockholm (SE)

(72) Inventors: Jalil TAGHIA, Stockholm (SE); Andreas JOHNSSON, Uppsala (SE); Farnaz MORADI, Bromma (SE); Hannes LARSSON, Solna (SE); Masoumeh EBRAHIMI, Solna (SE); Xiaoyu LAN, Täby (SE)

(73) Assignee: Telefonaktiebolaget LM Ericsson (publ), Stockholm (SE)

(21) Appl. No.: 18/998,868

(22) PCT Filed: Jul. 28, 2023
(86) PCT No.: PCT/SE2023/050759

§ 371 Date: Jan. 27, 2025

Related U.S. Application Data
(60) Provisional application No. 63/392,958, filed on Jul. 28, 2022.

(51) Int. Cl. G06N 3/098

(52) U.S. Cl. CPC G06N 3/098

(57) ABSTRACT

A computer-implemented method is provided performed by a client computing device for decentralized learning based on local learning at the client computing device is provided. The method includes training a local M, model based on an activation function using a local parameter set and a reference parameter set to obtain a setting for respective 5 local parameters in the local parameter set that minimizes a training loss wherein the activation function preserves agreements and discourages disagreements between the local parameter set and the reference parameter set. The method further includes sending the trained local ML model to a server computing device. The method further includes receiving, from the server computing device, a global ML model that meets a convergence criterion. A 10 method performed by a server computing device, and related methods and apparatuses are also provided.

### TECHNICAL FIELD

The present disclosure relates generally to methods performed by a client computing device and by a server computing device for decentralized learning based on local learning at the client computing device, and related methods and apparatuses.

### BACKGROUND

Federated learning may be seen as a form of distributed learning under strict privacy constraints with respect to sharing data, where participating agents that is the local computing devices in a federation collaboratively learn a global machine learning (ML) model, also referred to herein as a “global model” without having to share their local data. Learning of the global model in some approaches for federated learning involves two phases, local learning and global aggregation. Learning may involve back-and-forth communication rounds in between the agents and a server entity. In some approaches of federated learning, learning includes two phases of local learning at the agents that is the client computing devices and global aggregation at the server computing device. At the local learning phase, agents update their local ML models, also referred to herein as “local models” given the global model and their local data. At the global aggregation phase, an aggregated model is learned by aggregating for e.g., averaging the local models from the agents into a single global model.

However, there may be an overhead cost associated with the communication rounds. Approaches for reducing communication overhead may include: (1) reducing the amount of information that needs to be transferred at each round of federation; and/or (2) reducing the number of rounds needed to achieve convergence to a reasonably satisfactory solution.

Approaches may be lacking regarding the degree of model fitness at the local phase of learning and its effect on the overall communication cost. If agents learn under-fitted models to their local data, the global model may need many rounds to converge to the desired solution. Conversely, if agents learn over-fitted models, the global model may diverge or converge to a poor solution. A potential challenge regarding the degree of model fitness includes that it is unclear under which circumstances a trained model is regarded as an under-fitted or as an over-fitted model. This potential challenge may become particularly pronounced when agents have limited data, or when data is not fully representative of the true distribution of data. The degree of model fitness not only affects the quality of the final solution but also can affect the needed number of rounds before a reasonable solution is reached.

### SUMMARY

There currently exist certain challenges. A method may be lacking for ML model fitness at a local phase of learning that converges to a reasonable solution in a reduced or effective number of communication rounds.

Certain aspects of the disclosure and their embodiments may provide solutions to these or other challenges.

In various embodiments of the present disclosure, a computer-implemented method performed by a client computing device for decentralized learning based on local learning at the client computing device is provided. The method includes training a local ML model based on an activation function using a local parameter set and a reference parameter set to obtain a setting for respective local parameters in the local parameter set that minimizes a training loss wherein the activation function preserves agreements and discourages disagreements between the local parameter set and the reference parameter set. The method further includes sending the trained local ML model to a server computing device. The trained local ML model includes the settings of the respective local parameters. The method further includes receiving, from the server computing device, a global ML model that meets a convergence criterion. The global ML model includes a global parameter set including an aggregation of the settings of the respective local parameters from the client computing device and the settings of respective local parameters from at least one additional client computing device.

In other embodiments, a computer-implemented method performed by a server computing device for decentralized learning based on local learning at a plurality of client computing devices is provided. The method includes receiving a respective trained local ML model from respective client computing devices in the plurality of client computing devices. The respective trained local ML model includes a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set. The method further includes aggregating the settings of the respective local parameters from the respective client computing devices to obtain a global parameter set; and sending, to the respective client computing devices, a global ML model including the global parameter set that meets a convergence criterion.

In other embodiments, a client computing device is provided. The client computing device is configured for decentralized learning based on local learning at the client computing device. The client computing device includes processing circuitry; and at least one memory coupled with the processing circuitry. The memory includes instructions that when executed by the processing circuitry causes the client computing device to perform operations. The operations include to train a local ML model based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to send the trained local ML model to a server computing device. The trained local ML model includes the settings of the respective local parameters. The operations further include to receive, from the server computing device, a global ML model that meets a convergence criterion. The global ML model includes a global parameter set including an aggregation of the settings of the respective local parameters from the client computing device and the settings of respective local parameters from at least one additional client computing device.

In other embodiments, a client computing device is provided that is configured for decentralized learning based on local learning at the client computing device. The client computing device is adapted to perform operations. The operations include to train a local ML model based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to send the trained local ML model to a server computing device. The trained local ML model includes the settings of the respective local parameters. The operations further include to receive, from the server computing device, a global ML model that meets a convergence criterion. The global ML model includes a global parameter set including an aggregation of the settings of the respective local parameters from the client computing device and the settings of respective local parameters from at least one additional client computing device.

In other embodiments, a computer program comprising program code is provided to be executed by processing circuitry of a client computing device configured for decentralized learning based on local learning at the client computing device. Execution of the program code causes the client computing device to perform operations. The operations include to train a local ML model based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to send the trained local ML model to a server computing device. The trained local ML model includes the settings of the respective local parameters. The operations further include to receive, from the server computing device, a global ML model that meets a convergence criterion. The global ML model includes a global parameter set including an aggregation of the settings of the respective local parameters from the client computing device and the settings of respective local parameters from at least one additional client computing device.

In other embodiments, a computer program product is provided comprising a non-transitory storage medium including program code to be executed by processing circuitry of a client computing device configured for decentralized learning based on local learning at the client computing device. Execution of the program code causes the client computing device to perform operations. The operations include to train a local ML model based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to send the trained local ML model to a server computing device. The trained local ML model includes the settings of the respective local parameters. The operations further include to receive, from the server computing device, a global ML model that meets a convergence criterion. The global ML model includes a global parameter set including an aggregation of the settings of the respective local parameters from the client computing device and the settings of respective local parameters from at least one additional client computing device.

In other embodiments, a server computing device is provided. The server computing device is configured for decentralized learning based on local learning at a plurality of client computing devices. The server computing device includes processing circuitry; and at least one memory coupled with the processing circuitry. The memory includes instructions that when executed by the processing circuitry causes the server computing device to perform operations. The operations include to receive a respective trained local ML model from respective client computing devices in the plurality of client computing devices. The respective trained local ML model includes a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to aggregate the settings of the respective local parameters from the respective client computing devices to obtain a global parameter set; and to send, to the respective client computing devices, a global ML model including the global parameter set that meets a convergence criterion.

In other embodiments, a server computing device is provided that is configured for decentralized learning based on local learning at a plurality the client computing devices. The server computing device is adapted to perform operations. The operations include to receive a respective trained local ML model from respective client computing devices in the plurality of client computing devices. The respective trained local ML model includes a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to aggregate the settings of the respective local parameters from the respective client computing devices to obtain a global parameter set; and to send, to the respective client computing devices, a global ML model including the global parameter set that meets a convergence criterion.

In other embodiments, a computer program comprising program code is provided to be executed by processing circuitry of a server computing device configured for decentralized learning based on local learning at a plurality of client computing devices. Execution of the program code causes the server computing device to perform operations. The operations include to receive a respective trained local ML model from respective client computing devices in the plurality of client computing devices. The respective trained local ML model includes a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to aggregate the settings of the respective local parameters from the respective client computing devices to obtain a global parameter set; and to send, to the respective client computing devices, a global ML model including the global parameter set that meets a convergence criterion.

In other embodiments, a computer program product is provided including a non-transitory storage medium including program code to be executed by processing circuitry of a server computing device configured for decentralized learning based on local learning at a plurality of client computing devices. Execution of the program code causes the server computing device to perform operations. The operations include to receive a respective trained local ML model from respective client computing devices in the plurality of client computing devices. The respective trained local ML model includes a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set. The operations further include to aggregate the settings of the respective local parameters from the respective client computing devices to obtain a global parameter set; and to send, to the respective client computing devices, a global ML model including the global parameter set that meets a convergence criterion.

Certain embodiments may provide one or more of the following technical advantages. Based on the inclusion of local learning through an activation function using a local parameter set and a reference parameter set, communication cost may be reduced in decentralized learning by reducing a number of rounds to achieve convergence to a reasonable solution.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a is a schematic diagram illustrating an overview of a decentralized learning environment in accordance with some embodiments of the present disclosure;

FIG. 2 is schematic diagram illustrating an overview of operations of an example embodiment of one round of communication between an client computing device and a server computing device in accordance with the present disclosure;

FIG. 3 is a block diagram of learning in accordance with some embodiments of the present disclosure;

FIG. 4 is a flowchart of operations in accordance with some embodiments of the present disclosure;

FIG. 5 is a flow chart of operations of a client computing device in accordance with some embodiments of the present disclosure;

FIG. 6 is a flow chart of operations of a server computing device in accordance with some embodiments of the present disclosure;

FIG. 7 is a block diagram of a client computing device in accordance with some embodiments of the present disclosure; and

FIG. 8 is a block diagram of a server computing device in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As used herein, the term “client computing device” refers to equipment capable, configured, arranged, and/or operable for decentralized learning based on local learning at the client computing device. As discussed further herein, examples of client computing devices include, but are not limited to, a computer, a decentralized edge device, a decentralized edge server, and a user equipment (UE). The UE may include, e.g., a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

As used herein, the term “server computing device” refers to equipment capable, configured, arranged, and/or operable for decentralized learning based on local learning at a plurality of client computing devices. As discussed further herein, examples of server computing devices include, but are not limited to, a server, centralized or distributed base stations (BS) in a radio access network (RAN) (e.g., g Node Bs (gNBs), evolved Node Bs (eNBs), core network nodes, access points (APs) (e.g., radio access points) etc.).

As used herein, the term “decentralized learning” refers to any type of distributed or collaborative learning. As discussed further herein, an example of decentralized learning includes, but are not limited to, federated learning.

Data-driven ML based approaches play an important role in achieving a goal of zero-touch management of telecommunication networks. Data collected from monitoring network infrastructure, such as service key performance metrics, may be used to learn performance predictive models which may enable automation of management tasks and delivery of services, ranging across spectrum management and beamforming, resource and slice orchestration, service assurance, energy efficiency optimization, and root-cause analysis.

Telecom vendors and providers may deliver services with strict requirements on performance over complex and at times distributed network infrastructures. Meeting the requirements may involve continuous monitoring of the services and pervasive measurement points throughout the network; for example, in the remote-radio heads, the basebands, the core network, and central data centers. This may generate large volumes of data. Transferring such data over the network introduces overhead which increases the cost and can adversely impact the performance of the network and its services. Additionally, transferring data may be prohibited due to privacy regulations. For example, data from service performance metrics may be regarded as private; the infrastructure can be hosting services from different network slices sharing the common physical resources (such as radio and network) which should be kept isolated from each other; different services can belong to different domains as they are either managed by different network providers or are executed over geographically distributed domains with different privacy guidelines.

In addition to potential challenges with respect to data, there may be additional challenges with respect to having limited compute resources in one central node which can limit training and deployment of certain ML-based solutions. Hence, there has been interest in distributed learning approaches, such as federated learning. Federated learning is an approach that may facilitate collaborative learning in a distributed environment while providing certain degrees of guarantees on data privacy.

Federated learning may be viewed as an approach to distributed learning in which agents (such as operators, IoT devices) participate in a federation to collaboratively learn a global ML model without having to share their local data. Learning involves back-and-forth communication rounds in between the agents i.e., local computing devices and a server entity. One approach of federated learning includes two phases of local learning at the agent nodes and global aggregation at the server node. At the local learning phase, agents update their local ML models given the global ML model and their local data. At the global aggregation phase, an aggregated ML model is learned by aggregating (e.g., averaging) the local ML models from the agents into a single global ML model.

As discussed above, there currently exist certain challenges. For example, with respect to federated learning potential challenges exist including, without limitation, with respect to system heterogeneity, data heterogeneity, and communication overhead cost associated with transferring the ML model from agent nodes to the server and vice versa.

Approaches may try to reduce communication overhead with respect to federated learning, but challenges remain.

In an approach, the amount of information that needs to be transferred at each round may be reduced. For example, early stopping may be used at the local learning phase based on data samples from a validation set (e.g., a portion of a training set) or choosing the ML model that performs best on the validation set. However, a validation set that is representative of the data may not always be available, e.g., in scenarios where there are only a few data samples available for training at a client computing device, or where data of different agents are non-independently and identically distributed (non-i.i.d.) i.e., in other words, agents' local data is poorly representative of the task underlying the use case. Decentralized learning (e.g., federated learning), however, may have particular relevance in such scenarios.

As previously discussed above, other approaches may be related to the degree of model fitness at the local phase of learning and its effect on overall communication overhead. One approach may construct ML models that may be robust to overfitting. An approach for doing so may be through solving a constrained optimization problem where an aim, at the training phase, is to find a setting of the local parameter set that minimizes a given agent's learning loss while deviating as little as possible from the global parameter set.

Some approaches may try to solve such a constrained optimization problem via a class of heuristic techniques that may be referred to as penalty methods by adding a penalty function to an objective function that includes a penalty parameter multiplied by a measure of violation of the constraints. For example, Sahu, A., Li, T., Sanjabi, M., Zaheer, M., Talwalkar, A. S., & Smith, V., “Federated Optimization in Heterogeneous Networks”, arXiv: Learning (2020), describes a penalty function that is the Euclidean norm between the local parameter set and the global parameter set. In another example, Karimireddy, S. P., Kale, S., Mohri, M., Reddi, S. J., Stich, S. U., & Suresh, A. T., “SCAFFOLD: Stochastic Controlled Averaging for Federated Learning”, ICML (2020), describes a more involved penalty function that is a measure of the drift between local and global parameter set. In such approaches, however, choosing the right penalty parameter may be difficult and may be consequential in potential success of the approach. In other words, relaxing a constrained optimization problem by adding a penalty function to the objective loss function can be seen as penalizing the loss where the penalty parameter dictates the strength of the penalization. Moreover, settings of penalty parameters may be data dependent, and may need to be selected through cross-validation techniques.

Thus, a method may be lacking that can relax constrained optimization in training ML models (e.g., neural networks) and reduce the number of rounds needed to achieve convergence to a reasonably satisfactory solution.

Certain aspects of the disclosure and their embodiments may provide solutions to these or other challenges. In some embodiments, an activation function(s) (1) is applied to the local parameters of neural networks as opposed to its layer representation, and (2) uses a reference parameter set that can be understood as a mask that is applied to the local parameter set during learning. For a neural network as the underlying predictive model, this may translate into passing the model local parameters through an activation function that is applied element wise and is designed to discourage contrasts between the corresponding elements of the local parameter set and the global parameter set. Thus, in contrast to some approaches that may relax a constrained optimization problem into an unconstrained one through directly regulating a loss function, the method of the present disclosure may directly regulate the parameter set with an activation function(s) (discussed further herein) in decentralized learning. Technical advantages of inclusion of the activation function(s) may include that the method may refrain local models from overfitting to local data, which may lead to improved convergence in terms of quality of the solution and/or convergence rate. A further technical advantage of inclusion of the activation function(s) may be that the activation function(s) discourages learning local models that contrast largely from a global model, which may result in local models that are less prone to overfitting.

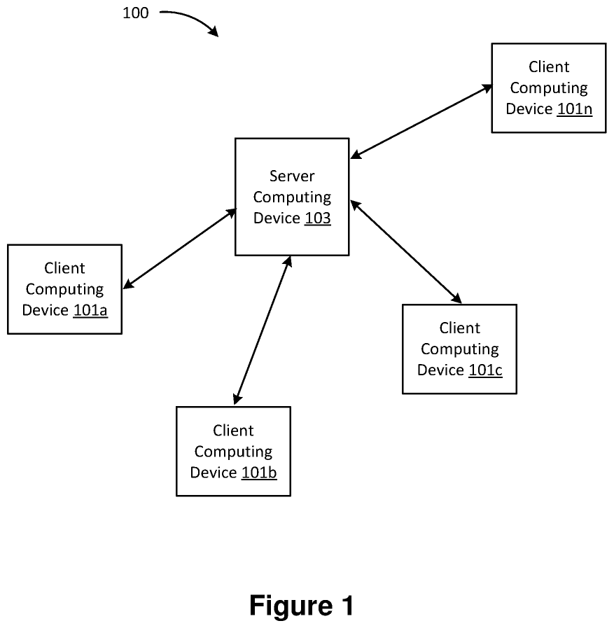

FIG. 1 is a schematic diagram illustrating an overview of a decentralized learning environment 100. As illustrated, four client computing devices 101a, 101b, 101c, 101n, hereinafter referred collectively as 101, are in communication with server computing device 103. While the example embodiment of FIG. 1 illustrates four client computing devices, the method of the present disclosure is not so limited and may include any non-zero number of client computing devices.

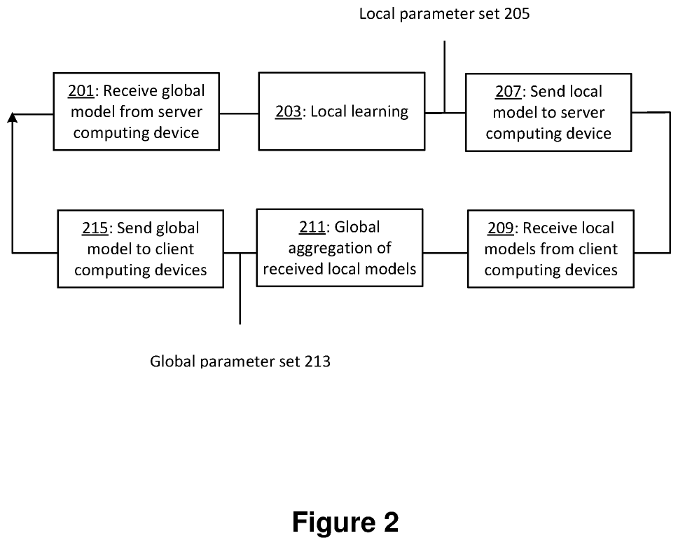

FIG. 2 is schematic diagram illustrating an overview of operations of an example embodiment of one round of communication between a client computing device (e.g., client computing device 101) and a server computing device (e.g., server computing device 103) in accordance with some embodiments of the present disclosure. Operations of the method are discussed herein with respect to example embodiments. While the example embodiments are explained in the non-limiting context of neural networks as the underlying predictive model in federated learning, the present disclosure is not so limited. Instead, other models in decentralized learning may be used.

Referring to FIG. 2, the operations include receiving 201, at respective client computing devices (e.g., client computing devices 101a, 101b, 101c, 101n), a global ML model from the server computing device 103. The global ML model includes a global ML model parameter set. The global parameter set may be initialized randomly and sent to the client computing devices. A respective client computing device constructs “contrastive layers” (discussed further herein) by setting its reference parameters [symbol] and initializing its local ML model's optimizable local parameter sets [symbol] with the global model parameter set received in operation 201.

The training i.e., learning function may then follow by cycling through, e.g., two phases of local learning at the client computing devices 101 and global aggregation at the server computing device 103. Thus, in operation 203, the respective client computing devices 101 perform local learning. Respective client computing devices 101 begin with both setting their reference parameters and initializing their local models' optimizable local parameter sets θ 205 with the global model parameter set θ̅ received from the server computing device 103. The client computing devices 101 train their models for J epochs given the local data. During training, the reference parameter set remains unaltered while the optimizable local parameter set may adapt in direction of minimizing the optimization loss. Later during the training, the reference parameter set may be altered if an alternative or updated parameter reference set is to be used as per training requirements. The term optimizable local parameter set herein may be interchangeable and replaced with the terms “local model parameter set” or a “local parameter set”.

Training may be carried out via training of a neural network via back propagation. For example, implementation of neural networks with contrastive layers may involve only changing the forward pass. Since the activation function(s) may be differentiable, backpropagation can follow using automatic differentiation techniques (e.g., in PyTorch or TensorFlow).

In operation 207, a respective client computing device (e.g., client computing devices 101a, 101b, 101c, 101n) sends the local ML model including the local parameter set [symbol] , 205 to the server computing device 103. In operation 209, the server computing device 103 receives local ML models including the local parameter set, [symbol] 205 from the respective client computing devices (e.g., client computing devices 101a, 101b, 101c, 101n). In operation 211, the server computing device 103 constructs an aggregated ML model (that is, global aggregation of the received local models). For example, the server computing device may compute an aggregated parameter set [symbol] 213 (also referred to herein as a “global parameter set”). The method of aggregation may depend on the framework of decentralized learning. For example, aggregation may be a simple averaging operation. In operation 215, the server computing device 103 sends the global ML model including the global parameter set 213 to the respective client computing devices (e.g., client computing devices 101a, 101b, 101c, 101n).

Operations 201-215 of FIG. 2 may be repeated until a convergence criterion is met. One pass through operations 201-215 may be referred to as a “round”. The convergence criterion may be based on monitoring a change in global model parameter set 213 in successive rounds. In some embodiments, if the change is smaller than a threshold, learning is terminated. In other embodiments, the convergence criterion is based on reaching a certain number of rounds. In yet another embodiment, the convergence criterion for terminating learning is a combination of monitoring a change in global model parameter set 213 in successive rounds and reaching a certain number of rounds.

As used herein, the term “activation function” with respect to an activation function using a local parameter set and a reference parameter set may be interchangeable and replaced with the term “contrastive activation function”. The activation function maybe an activation function that preserves agreements and discourages disagreements between the local parameter set and the reference parameters set. In an example embodiment, the activation function comprises a function of a ML model that is designed to preserve agreements and penalize disagreements between a local parameter set (e.g., θ) and a reference parameter set (e.g., θ̅).

Inputs to an activation function include (1) a local parameter set (e.g., θ∈Θ) that may need optimization, and (2) a reference parameter set (e.g., θ̅∈Θ̅) that does not need optimization. The two parameter sets (e.g., θ and θ̅), have the same dimensionality. The reference parameter set (e.g., θ) may be understood as a mask that is multiplied element wise to the local parameter set (e.g., θ).

In example embodiments, the following notation is used herein for ease of discussion: the local parameter set θ[i, j]=θ; the reference parameter set θ̅[i, j]=θ̅; and sgn denotes a signum function. The activation function g may be understood as a “contrastive activation function” (as discussed further herein). In an example embodiment, the activation function g satisfies the following conditions:

$$sgn ( θ ) \neq sgn ( \overline{θ} ) ⇒ g ( \overline{θ} , θ ) \to 0 ; \qquad ( 1 )$$

$$θ = \overline{θ} ⇒ g ( \overline{θ} , θ ) \to θ ; \qquad ( 2 )$$

$$sgn ( θ ) = s g n ( \overline{θ} ) , θ ≫ \overline{θ} ⇒ \overline{θ} < g ( \overline{θ} , θ ) ≪ θ ; \qquad ( 3 )$$

$$sgn ( θ ) = sgn ( \overline{θ} ) , θ ≪ \overline{θ} ⇒ θ < g ( \overline{θ} , θ ) ≪ θ \qquad ( 4 )$$

The activation function g is approximately differentiable almost everywhere.

An example embodiment of an implementation of the activation function satisfying the above referenced conditions is as follows:

$$g ( \overline{θ} , θ ) = sgn ( \overline{θ} , θ ) \sqrt{ε + ReLU ( \overline{θ} ⊙ θ} ,$$

where ⊙ indicates element-wise multiplication, ReLU denotes a rectified linear activation function, and ε is a small positive number (e.g., 10⁻⁸) added for numerical stability. In an example embodiment, if θ and θ̅ have opposite signs, the contrast between the two is maximal. The disagreement is settled by setting it to a value close to zero. If θ is in full agreement with the reference θ̅, both in sign and strength, the agreement is preserved. If θ and θ̅ have the same sign but contrast in their strength such that the strength of one is much larger than the other, the output is skewed towards the one with the smaller strength.

Some embodiments include construction of a ML model comprising a neural network with layers including the contrastive activation function in “contrastive layers”. An example embodiment includes a multi-layer perception (MLP) neural network:

$$\{ \begin{matrix}\hat{y} = {h}^{3} ( {W}^{2} {h}^{2} + {b}^{3} ) , \\ {h}^{2} = {h}^{2} ( {W}^{2} {h}^{1} + {b}^{2} ) , \\ {h}^{1} = {h}^{1} ( {W}^{1} x + {b}^{1} ) ,\end{matrix}$$

where h^{l} is a layer activation function, h^{l} is the vector of hidden layer representations, the pair of W^{l} and b^{l} denotes the weight matrix and the bias vector which need optimization, x denotes the input data and ŷ denotes the output response.

In this example embodiment, the corresponding neural network with contrastive layers is constructed as:

$$\{ \begin{matrix}\hat{y} = {h}^{3} ( g ( {W}^{3} , {\overline{W}}^{3} ) {h}^{2} + g ( {b}^{3} , {\overline{b}}^{3} ) , \\ {h}^{2} = {h}^{2} ( g ( {W}^{2} {\overline{W}}^{2} ) {h}^{1} + g ( {b}^{2} , {\overline{b}}^{2} ) , \\ {h}^{1} = {h}^{1} ( g ( {W}^{1} , {\overline{W}}^{1} ) x + g ( {b}^{1} , {\overline{b}}^{1} ) ,\end{matrix}$$

where g is a contrastive activation function at layer l, and W̅ and b̅ are weights and biases from a reference model. The same, or different, contrastive activation functions may be included for all layers g^{l}:=g∀l. Classes of neural networks may include MLPs, recurrent neural nets, convolutional neural nets, etc. Depending on the class of neural networks, a layer, local parameter set Θ may include different types of weight matrices and bias vectors.

In some embodiments, in a general form, for a neural network f, the corresponding neural network with contrastive layers is expressed as:

$${f}_{\underline{θ} \vert \underline{\overline{θ}} ( x )} = ( {f}_{{θ}^{1} \vert {\overline{θ}}^{1}}^{1} ∘ {f}_{{θ}^{2} \vert {\overline{θ}}^{2}}^{2} ∘ … ∘ {f}_{{θ}^{L} \vert {\overline{θ}}^{L}}^{L} ) ( x ) ,$$

where ° denotes the function composition, and the notation [symbol] is used to emphasize on dependence on the reference parameter set at the layer l. Given [symbol] , the training involves finding a setting of [symbol] that minimizes the loss [symbol] (y, ŷ) defined between true response y and its prediction ŷ=f_{θ|θ̅}(x).

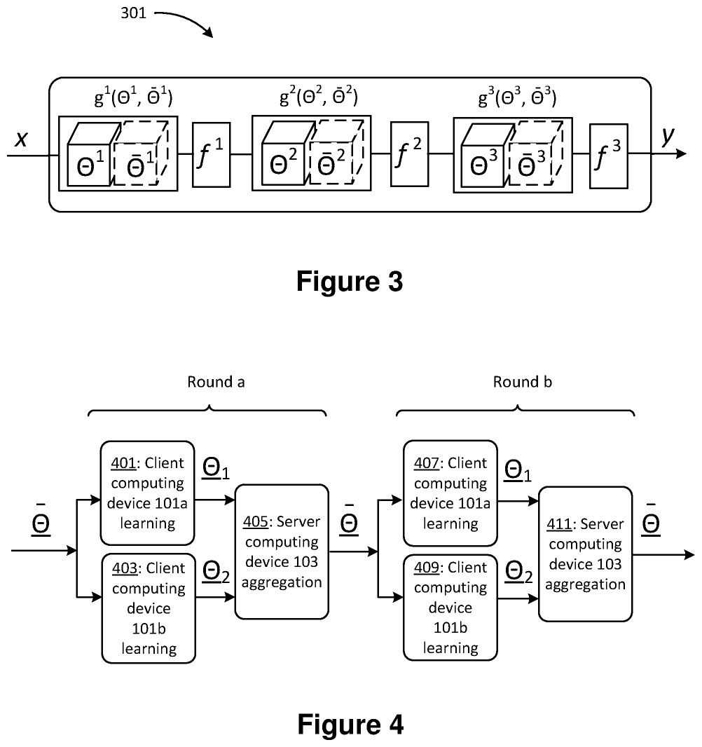

FIG. 3 is a block diagram of learning in accordance with some embodiments of the present disclosure. In FIG. 3, Θ^{l} denotes neural network parameters as the layer l (such as weight matrices and bias vectors) of a neural network including L layers; Θ̅^{l} denotes the reference parameter set at the layer l; f^{l} denotes the layer activation function at the layer l (such as ReLU or Tanh); g^{l}(Θ^{l}, Θ̅^{l}) denotes the contrastive activation function at the layer l; X denotes the input data; y denotes the output response. Training of the neural network may be done through backpropagation. FIG. 3 illustrates a forward pass of the training.

FIG. 4 is a flowchart of operations in accordance with some embodiments of the present disclosure. As illustrated in FIG. 4, federated learning is shown through contrastive learning, referred to herein as “contrastive federated learning”. As previously discussed, FIG. 3 is a block diagram illustrating contrastive learning. FIG. 4 illustrates two successive rounds A and B of federated learning between two agents, but the present disclosure is not so limited, and includes any number of agents. Initially, at the start of Round A the global ML model [symbol] is provided to the client computing devices 101a and 101b as input. At 401 and 402, the received the client computing devices 101a and 101b performs contrastive federated learning of their respective local ML models Θ and provides the trained local ML models [symbol] ₁ and [symbol] ₂ to the server computing device 103. At 405, the server computing device performs the aggregation of the local ML models received to generate the trained global ML model [symbol] which is provided to the client computing devices 101a and 101b as input, at the start of Round B wherein the steps 407, 409 and 411 are repeated as similar to the corresponding steps 401, 402 and 405.

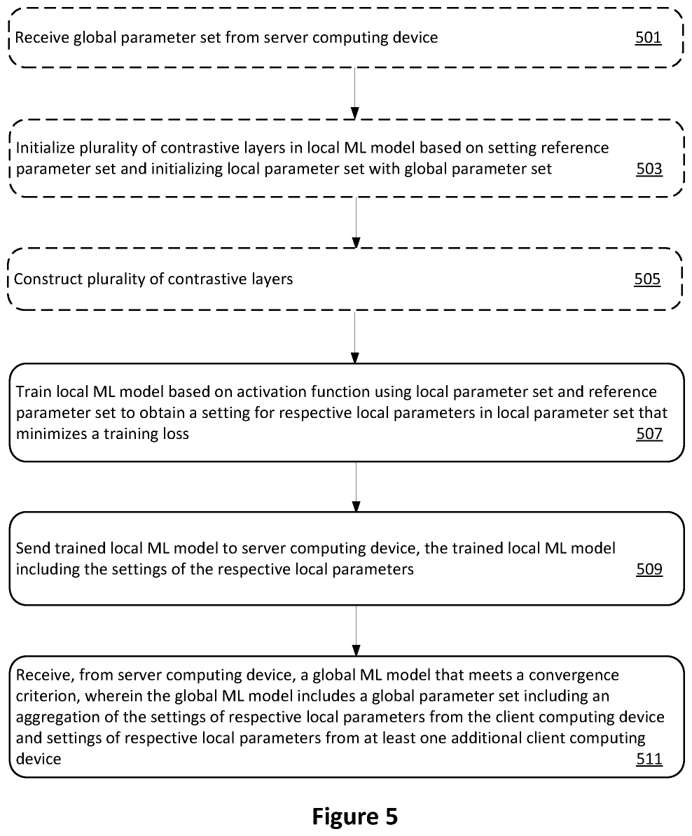

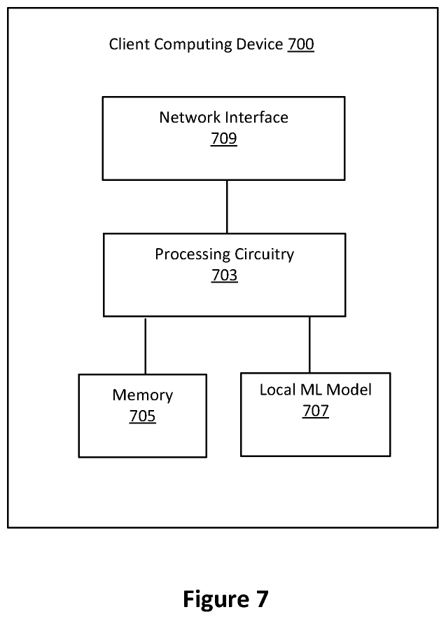

Operations of a client computing device 700 (implemented using the structure of the block diagram of FIG. 7) will now be discussed with reference to the flow chart of FIG. 5 according to some embodiments of the present disclosure. For example, modules may be stored in memory 705 of FIG. 7, and these modules may provide instructions so that when the instructions of a module are executed by respective client computing device processing circuitry 703, processing circuitry 703 performs respective operations of the flow chart.

Referring to FIG. 5, a computer-implemented method performed by the client computing device 101, 700 for decentralized learning based on local learning at the client computing device 101, 700 is provided. The method includes training (507) a local ML model based on an activation function using a local parameter set and a reference parameter set to obtain a setting for respective local parameters in the local parameter set that minimizes a training loss. The method further includes sending (509) the trained local ML model to a server computing device 103, 800. The trained local ML model includes the settings of the respective local parameters. The method further includes receiving (511), from the server computing device 103, 800, a global ML model that meets a convergence criterion. The global ML model includes a global parameter set including an aggregation of the settings of the respective local parameters from the client computing device 101, 700 and the settings of respective local parameters from at least one additional client computing device 101, 700.

In some embodiments, the activation function preserves agreements and discourages disagreements between the local parameter set and the reference parameter set.

In some embodiments, typically the reference parameter set remains unaltered throughout the training. Later during the training, the reference parameter set may be altered if an alternative or updated parameter reference set is to be used as per training requirements.

The training loss may include a loss defined between a first output response of the local ML model and a second output response of the local ML model including the activation function.

The training (507) may include passing the local parameter set through the activation function to preserve agreements and to penalize disagreements between the local parameter set and the reference parameter set.

The passing may include element wise multiplication of the reference set of parameters with the local parameter set.

The setting of respective local parameters of the local parameter set may include one of (i) a value of zero when a respective local parameter and a respective reference parameter have opposite signs and approximately the same value, (ii) a present value when the respective local parameter and the respective reference parameter have a same sign and the present value that is approximately the same value, and (iii) a smaller value when the respective local parameter and the respective reference parameter have the same sign but one of the respective local parameter and the respective reference parameter has the smaller value and the other has a larger value.

In some embodiments, the training (507), the sending (509), and the receiving (511) is a first portion of a round of communication between the client computing device 101, 700 and the server computing device 103, 800, and the convergence criterion includes at least one of (i) a change in a value of respective global parameters from the global parameter set in successive rounds that is less than a threshold value, (ii) meeting a specified number of rounds, and (iii) a combination of the change in the value and the meeting the specified number of rounds.

In some embodiments, the method further includes receiving (501) the global parameter set from the server computing device 103, 800; initializing (503) a plurality of contrastive layers in the local ML model based on setting the reference parameter set and initializing the local parameter set with the global parameter set; and constructing (505) the plurality of contrastive layers.

The local ML model may include a neural network including a plurality of layers, a respective layer may include the local parameter set, and a respective local parameter in the local parameter set may include a weight matrix and a bias vector. The constructing (505) may include multiplication, for a respective layer of

the neural network, of the weight matrix of a respective local parameter with the activation function, the bias vector of the respective local parameter with the activation function, the weight matric of a respective reference parameter with the activation function, and the bias vector of the respective reference parameter with the activation function.

In some embodiments, the activation function is included in at least one of (i) each of the plurality of layers of the neural network, (ii) or selected layers from the plurality of layers of the neural network.

In some embodiments, the activation function includes a plurality of activation functions including at least one of (i) the plurality of activation functions having a functional form that is the same, or (ii) at least one of the plurality of activation functions having a functional form that is different than a functional form of the remaining of the plurality of activation functions; and at least two layers from the plurality of layers of the neural network respectively include at least one of (i) the plurality of activation functions having the functional form that is the same, or (ii) a first activation function of a first layer that has a functional form that is different than a functional form of a second activation function of a second layer.

The training (507) may be applied during at least one of (i) each epoch during the training, or (ii) selected epochs.

The converged global ML model may be applied to perform tasks including to obtain key performance indicators, KPIs, in at least one of a telecommunications network or to classify image data.

The client computing device 101, 700 may include at least one of a computer, a decentralized edge device, a decentralized edge server, and a user equipment.

The server computing device 103, 800 may include at least one of a server, a base station, a core network node, and an access point.

Various operations from the flow chart of FIG. 5 may be optional with respect to some embodiments of client computing devices and related methods. For example, operations of blocks 501, 503, and/or 505 of FIG. 5 may be optional.

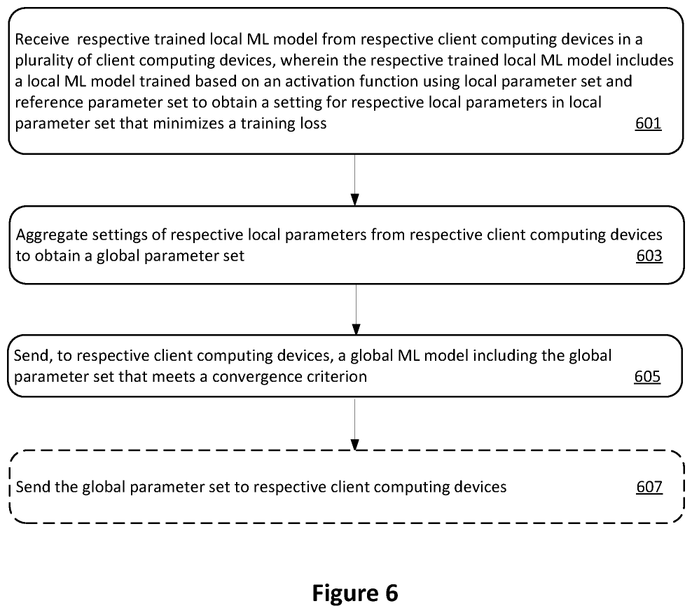

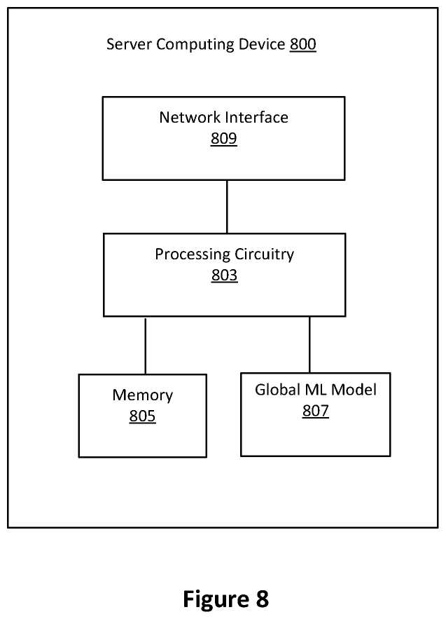

Operations of a server computing device 800 (implemented using the structure of the block diagram of FIG. 8) will now be discussed with reference to the flow chart of FIG. 6 according to some embodiments of the present disclosure. For example, modules may be stored in memory 805 of FIG. 8, and these modules may provide instructions so that when the instructions of a module are executed by respective server computing device processing circuitry 803, processing circuitry 803 performs respective operations of the flow chart.

Referring to FIG. 6, a computer-implemented method performed by the server computing device 103, 800 for decentralized learning based on local learning at a plurality of client computing devices 101, 700 is provided. The method includes receiving (601) a respective trained local ML model from respective client computing devices in the plurality of client computing devices 101, 700. The respective trained local ML model includes a local ML model trained based on an activation function using a local parameter set and a reference parameter set to obtain a setting for respective local parameters in the local parameter set that minimizes a training loss. The method further includes aggregating (603) the settings of the respective local parameters from the respective client computing devices 101, 700 to obtain a global parameter set; and sending (605), to the respective client computing devices 101, 700, a global ML model including the global parameter set that meets a convergence criterion.

In some embodiments, the activation function preserves agreements and discourages disagreements between the local parameter set and the reference parameter set.

In some embodiments, typically the reference parameter set remains unaltered throughout the training. Later during the training, the reference parameter set may be altered if an alternative or updated parameter reference set is to be used as per training requirements.

In some embodiments, the receiving (601), the aggregating (603), and the sending (605) are a second portion of a round of communication between the client computing device 101, 700 and the server computing device 103, 800, and the convergence criterion includes at least one of (i) a change in a value of respective global parameters from the global parameter set in successive rounds that is less than a threshold value, (ii) meeting a specified number of rounds, and (iii) a combination of the change in the value and the meeting the specified number of rounds.

The training loss may include a loss defined between a first output response of the local ML model and a second output response of the local ML model comprising the activation function.

Training of the trained local ML model may include passing the local parameter set through the activation function to preserve agreements and to penalize disagreements between the local parameter set and the reference parameter set. The passing may include element wise multiplication of the reference set of parameters with the local parameter set.

The setting of respective local parameters of the local parameter set may include one of (i) a value of zero when a respective local parameter and a respective reference parameter have opposite signs and approximately the same value, (ii) a present value when the respective local parameter and the respective reference parameter have a same sign and the present value is approximately the same value, and (iii) a smaller value when the respective local parameter and the respective reference parameter have the same sign but one of the respective local parameter and the respective reference parameter has the smaller value and the other has a larger value.

In some embodiments, the method further includes sending (607) the global parameter set to the respective client computing devices 101, 700.

The local ML model may include a neural network including a plurality of layers, a respective layer may include the local parameter set, and the respective local parameters in the local parameter set may include a weight matrix and a bias vector.

In some embodiments, the activation function is included in at least one of (i) each of the plurality of layers of the neural network, (ii) or selected layers from the plurality of layers of the neural network.

In some embodiments, the activation function includes a plurality of activation functions including at least one of (i) the plurality of activation functions having a functional form that is the same, or (ii) at least one of the plurality of activation functions having a functional form that different than a functional form of the remaining of the plurality of activation functions; and at least two layers from the plurality of layers of the neural network respectively include at least one of (i) the plurality of activation functions having the functional form that is the same, or (ii) a first activation function of a first layer that has a functional form that is different than a functional form of a second activation function of a second layer.

The converged global ML model may be applied to perform tasks comprising to obtain key performance indicators, KPIs, in at least one of a telecommunications network or to classify image data.

Various operations from the flow chart of FIG. 6 may be optional with respect to some embodiments of server computing device 103, 800 and related methods. For example, operations of block 607 of FIG. 6 may be optional.

The following two example embodiments illustrate results of the method of the present disclosure compared to federated learning without the method of the present disclosure. A first example embodiment shows the application of the method in the telecommunications domain. A second example embodiment shows the application of the method for image data.

In the first example embodiment, publicly available traces were collected from a testbed environment. The testbed includes of a server cluster (e.g., a server computing device) and six client machines. There were two services running on these machines: Video-on-Demand (VOD) and a Key-Value (KV) store (database).

Traces were generated by executing experiments with different configurations of services and load patterns. The features were collected from the server cluster and service-level metrics (SLMs) were collected on the client machines.

Data included in the first example embodiment emulated a multi-operator environment of 24 operators (e.g., client computing devices). Each client computing device had a unique configuration based on an execution type, load pattern, and the client server machine.

Features were collected from Linux kernels on the server cluster machines. Examples of the features include central processing unit (CPU) utilization per core, memory utilization, network utilization and disk input/output (I/O). The task underlying the first example embodiment was prediction of SLMs given the features. The following Table 1 summarizes data specifications for traces for VoD services from a data center:

| | Configuration | | | | | |
|---|---|---|---|---|---|---|
| Agent | Load | Execution | Client | | Dataset | |
| Node | Pattern | Type | Machines | Tasks | x | y |
| VPSI-6 | Periodic | SingleApp | 1-6 | VoD (**) | 182 | 3 |
| VPBI-6 | Periodic | BothApps | 1-6 | VoD (**) | 182 | 3 |
| VFSI-6 | Flashcrowd | SingleApp | 1-6 | VoD(**) | 182 | 3 |
| VFBI-6 | Flashcrowd | BothApps | 1-6 | VoD (**) | 182 | 3 |

| | |
|---|---|
| ** VoD | Service level metrics: AvgInterDispDelay, |
| | AvgInterAudioPlayerDelay, NetReadAvgDelay |

In the second example embodiment, image data, FashionMNIST, was included. The data included ten different clothing items such as shoes and bags. The task in the second example embodiment was classification where the inputs were the pictures of the items, and the labels were the type of the items.

The data was split randomly into twenty client computing devices such that no client computing device had data representing all the labels. In other words, for the client computing devices to be able to correctly solve the problem, they needed to collaborate with other agent nods. Thus, the second example embodiment included heterogenous federated learning with respect to data distribution of the client computing devices.

The predictive ML model used in both the first and second example embodiments was a MLP neural network as the predictive model. The ML model included two layers, with fifty hidden units per layer. Two versions of this ML model used: (1) an MLP without contrastive layers, and (2) a MLP with contrastive layers in accordance with some embodiments. The following Table 2 shows the MLP model without contrastive layers, and Table 3 shows the MLP model with contrastive layers in accordance with some embodiments:

TABLE 2

| | Input | Hidden | Hidden | Output |
|---|---|---|---|---|
| MLP | layer | layer 1 | layer 2 | layer |
| Layer activation | ReLU | ReLU | ReLU | Linear |
| function | | | | |

| | |
|---|---|
| Loss function | Mean Squared Error |
| Optimizer | Adam (learning rate 0.01) |

TABLE 3

| MLP with | | | | |
|---|---|---|---|---|
| Contrastive | Input | Hidden | Hidden | Output |
| Layers | layer | layer 1 | layer 2 | layer |
| Layer activation | ReLU | ReLU | ReLU | Linear |
| function | | | | |
| Contrastive | True | True | True | True |
| activation | | | | |
| function | | | | |

| | |
|---|---|
| Loss function | Mean Squared Error |
| Optimizer | Adam (learning rate 0.01) |

In the first and second example embodiments, the following ML models were compared against each other:
Local learning (LL): In LL, the client computing devices did not collaborate in learning. The predictive model was the MLP model shown in Table 2.
   LL was included as the approximate lower bound on the performance in the comparison.
Central learning (CL): In CL, the client computing devices shared their data. Once data from all client computing devices are gathered in one place, the ML model is learned. The predictive model was the MLP shown in Table 2.
   It CL model was included as the approximate upper bound on the performance in this comparison.
Federated learning (FL) without contrastive learning: The learning continued for ten rounds. The predictive model was the MLP model shown in Table 2.
An example embodiment of contrastive federated learning (CFL) of the method of the present disclosure. The predictive model was the MLP model shown in Table 3.

In the first example embodiment, for evaluation of data center traces, normalized mean absolute error between the true service level metrics and the predicted service level metrics was used. Lower values (e.g., close to zero) were preferred.

In the second example embodiment, for evaluation of data on image data, classification accuracy was used. Maximum classification accuracy was 1, and chance accuracy was 0.1.

For the first example embodiment, performance of the LL, CL, FL, and CFL models in prediction of three different SLMs was performed. The three SLMs were AvgInterDispDelay, AvgInterAudioPlayerDelay, NetReadAvgDelay, as shown in Table 1 herein. The performance was evaluated in terms of mean absolute error (nMeanAE) between the true and measured SLMs and included (1) performance of the LL, CL, FL, and CFL models at each round of federation averaged across all twenty-four (24) client computing devices; (2) performance of the LL, CL, FL, and CFL models at the final round per client computing device. The learning for each ML model in the comparison, including the ML model of first example embodiment, was repeated five times and the average and standard deviation was obtained. Values closer to zero were preferred.

The results for the AvgInterDispDelay showed that the CFL method of the first example embodiment converged faster (about 1-3 rounds) and with a lower nMeanAE (about 0.25-0.26) than the FL model which converged in about 4 rounds and with a higher nMeanAE (about 0.29-0.30). Additionally, by about round 3-4, the nMeanAE of the CFL method was about the same as that of the CL included in the first example embodiment as the lower bound for the performance comparison, and was lower than the nMeanAE of about 2.4 of the LL included in the first example embodiment as the upper bound for the performance comparison. The performance of the LL, CL, FL, and CFL models at the final round per agent showed that the CFL method of the first example embodiment for each client computing device had a nMeanAE that was about the same as the CL method, and that was lower than the nMeanAE of the LL and the FL.

The results for the AvgInterAudioPlayedDelay showed that the CFL method of the first example embodiment converged faster (about 3 rounds) and with a lower nMeanAE (about 0.35) than the FL model which converged in about 6 rounds and with a higher nMeanAE (about 0.60). Additionally, by about round 3, the nMeanAE of the CFL method was about the same as that of the CL included in the first example embodiment as the lower bound for the performance comparison, and was lower than the nMeanAE of about 0.82 of the LL included in the first example embodiment as the upper bound for the performance comparison. The performance of the LL, CL, FL, and CFL models at the final round per agent showed that the CFL method of the first example embodiment for each client computing device had a nMeanAE that was about the same as the CL method, and that was lower than the nMeanAE of the LL and the FL.

The results for the NetReadAvgDelay showed that the CFL method of the first example embodiment converged faster (about 3-4 rounds) and with a lower nMeanAE (about 0.5) than the FL model which converged in about 6-7 rounds and with a higher nMeanAE (about 1.0). Additionally, by about round 3, the nMeanAE of the CFL method was about the same as that of the CL included in the first example embodiment as the lower bound for the performance comparison, and was lower than the nMeanAE of about 2.4 of the LL included in the first example embodiment as the upper bound for the performance comparison. The performance of the LL, CL, FL, and CFL models at the final round per agent showed that the CFL method of the first example embodiment for each client computing device had a nMeanAE that was about the same as the CL method, and that was lower than the nMeanAE of the LL and the FL.

For the second example embodiment, performance of the accuracy of the LL, CL, FL, and CFL models in classification of image data was performed. The performance was evaluated in terms of accuracy mean and included (1) performance of the LL, CL, FL, and CFL models at each round of federation averaged across twenty (20) client computing devices; (2) performance of the LL, CL, FL, and CFL models at the final round per client computing device. Values closer to one were preferred.

The results showed that the CFL method of the second example embodiment was more accurate (about 0.6-0.7) in less rounds (in about 3-4 rounds) than the FL model which had an accuracy of about 0.5-0.6 in about 4 rounds. Additionally, by about round 3-4, the nMeanAE of the CFL method had greater accuracy (about 0.6-0.7) than the LL (about 0.42) included in the second example embodiment as the lower bound for the performance comparison, and approached the accuracy of the CL (about 0.78) that was included in the second embodiment as the upper bound for the performance comparison. The performance of the LL, CL, FL, and CFL models at the final round per agent showed that the CFL method of the second example embodiment for each client computing device had an accuracy that was greater per agent (about 0.6-0.7) than the FL method (about 0.5-0.65), and the LL method (about 0.34-0.48), and closer to the CL method (about 0.78-0.8).

Thus, certain embodiments may provide one or more of the following technical advantages: improved performance over federated learning without contrastive layers; a method that may be well-suited in heterogenous federated learning where underlying distribution of the participating client computing devices is heterogenous; a method that may be well-suited in online learning, where data is streamed at the client computing devices in batches of a few data samples at a time; the method may be applied to a large class of federated learning frameworks; and the method may be used for arbitrary architectures of neural networks including, e.g., MLP (e.g., fully connected neural networks), convolutional neural networks, recurrent neural networks, etc.

Example embodiments of the methods of the present disclosure may be implemented in a network that includes, without limitation a telecommunication network. The telecommunications network may include an access network, such as a RAN, and a core network, which includes one or more core network nodes. The access network may include one or more access nodes, such as network nodes (e.g., base stations), or any other similar Third Generation Partnership project (3GPP) access node or non-3GPP access point. The network nodes facilitate direct or indirect connection of client computing devices (e.g., a UE), such as by and/or other client computing devices to the core network over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the network may include any number of wired or wireless networks, network nodes, UEs, computing devices, and/or any other components or systems that may facilitate or participate in the communication of data and/or signals whether via wired or wireless connections. The network may include and/or interface with any type of communication, telecommunication, data, cellular, radio network, and/or other similar type of system.

As a whole, the network enables connectivity between the client computing devices and sever computing device(s). In that sense, the network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network is a cellular network that implements 3GPP standardized features. Accordingly, the telecommunications network may support network slicing to provide different logical networks to different devices that are connected to the telecommunication network. For example, the telecommunications network may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the network is not limited to including a RAN, and rather includes any that includes any programmable/configurable decentralized access point or network element that also records data from performance measurement points in the network.

In some examples, client computing devices and/or server computing devices are configured as a computer without radio/baseband, etc. attached.

Methods of the present disclosure may be performed by a client computing device (e.g., any client computing devices 101a-n of FIG. 1 (one or more of which may be generally referred to as client computing device 101), or client computing device 700 of FIG. 7). For example, modules may be stored in memory 705 and/or local ML model 707 of FIG. 7, and these modules may provide instructions so that when the instructions of a module are executed by processing circuitry 703 of FIG. 7, the client computing device performs respective operations of methods in accordance with various embodiments of the present disclosure.

Referring to FIG. 7, as previously discussed, a client computing device refers to equipment capable, configured, arranged, and/or operable for decentralized learning based on local learning at the client computing device. As discussed further herein, examples of client computing devices include, but are not limited to, a computer, a decentralized edge device, a decentralized edge server, and a user equipment (UE). The client computing device 700 includes processing circuitry 703 that is operatively coupled to a memory 705, local ML model 707, and/or any other component, or any combination thereof. Certain client computing devices may utilize all or a subset of the components shown in FIG. 7. The level of integration between the components may vary from one client computing device to another client computing device. Further, certain client computing devices may contain multiple instances of a component, such as multiple processors, memories, transceivers, transmitters, receivers, etc.

The processing circuitry 703 is configured to process instructions and data and may be configured to implement any sequential state machine operative to execute instructions stored as machine-readable computer programs in the memory 705 and/or the local ML model 707. The processing circuitry 703 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 703 may include multiple central processing units (CPUs).

The memory 705 and/or the local ML model 707 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 703 and/or the local ML model 707 includes one or more application programs, such as an operating system, web browser application, a widget, gadget engine, or other application, and corresponding data. The memory 705 and/or the local ML model 707 may store, for use by the client computing device 700, any of a variety of various operating systems or combinations of operating systems.

The memory 705 and/or the local ML model 707 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 705 and/or the local ML model 707 may allow the client computing device 700 to access instructions, application programs and the like, stored on transitory or non-transitory memory media, to off-load data, or to upload data. An article of manufacture, such as one utilizing a network may be tangibly embodied as or in the memory 705 and/or local ML model 707, which may be or comprise a device-readable storage medium.

The processing circuitry 703 may be configured to communicate with an access network or other network using a communication interface 709. The communication interface may comprise one or more communication subsystems and may include or be communicatively coupled to an optional antenna. The communication interface 709 may include one or more transceivers used to communicate, such as by communicating with one or more remote transceivers of another device capable of wireless communication (e.g., another computing device or a network node). Each transceiver may include a transmitter and/or a receiver appropriate to provide network communications (e.g., optical, electrical, frequency allocations, and so forth). Moreover, the optional transmitter and receiver may be coupled to one or more optional antennas and may share circuit components, software or firmware, or alternatively be implemented separately.

In the illustrated embodiment, communication functions of the communication interface 709 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Further methods of the present disclosure may be performed by a server computing device (e.g., server computing devices 103 of FIG. 1, or server computing device 800 of FIG. 8). For example, modules may be stored in memory 805 and/or global ML model 807 of FIG. 8, and these modules may provide instructions so that when the instructions of a module are executed by processing circuitry 803 of FIG. 8, the server computing device performs respective operations of methods in accordance with various embodiments of the present disclosure.

Referring to FIG. 8, as previously discussed, a server computing device refers to equipment capable, configured, arranged, and/or operable for decentralized learning based on local learning at a plurality of client computing devices. As discussed further herein, examples of server computing devices include, but are not limited to, a server, centralized or distributed BS in a RAN (e.g., gNBs, eNBs, core network nodes, APs (e.g., radio access points) etc.). The server computing device 800 includes processing circuitry 803 that is operatively coupled to a memory 805, global ML model 807, and/or any other component, or any combination thereof. Certain server computing devices may utilize all or a subset of the components shown in FIG. 8. The level of integration between the components may vary from one server computing device to another server computing device. Further, certain server computing devices may contain multiple instances of a component, such as multiple processors, memories, transceivers, transmitters, receivers, etc.

The processing circuitry 803 is configured to process instructions and data and may be configured to implement any sequential state machine operative to execute instructions stored as machine-readable computer programs in the memory 805 and/or the global ML model 807. The processing circuitry 803 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 803 may include multiple central processing units (CPUs).

The memory 805 and/or the global ML model 807 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 803 and/or the global ML model 807 includes one or more application programs, such as an operating system, web browser application, a widget, gadget engine, or other application, and corresponding data. The memory 805 and/or the global ML model 807 may store, for use by the server computing device 800, any of a variety of various operating systems or combinations of operating systems.

The memory 805 and/or the global ML model 807 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 805 and/or the global ML model 807 may allow the server computing device 800 to access instructions, application programs and the like, stored on transitory or non-transitory memory media, to off-load data, or to upload data. An article of manufacture, such as one utilizing a network may be tangibly embodied as or in the memory 805 and/or global ML model 807, which may be or comprise a device-readable storage medium.

The processing circuitry 803 may be configured to communicate with an access network or other network using a communication interface 809. The communication interface 809 may comprise one or more communication subsystems and may include or be communicatively coupled to an optional antenna. The communication interface 809 may include one or more transceivers used to communicate, such as by communicating with one or more remote transceivers of another device capable of wireless communication (e.g., another computing device or a network node). Each transceiver may include a transmitter and/or a receiver appropriate to provide network communications (e.g., optical, electrical, frequency allocations, and so forth). Moreover, the optional transmitter and receiver may be coupled to one or more optional antennas and may share circuit components, software or firmware, or alternatively be implemented separately.

In the illustrated embodiment, communication functions of the communication interface 809 may include cellular communication, Wi-Fi communication, LPWAN communication, data communication, voice communication, multimedia communication, short-range communications such as Bluetooth, near-field communication, location-based communication such as the use of the GPS to determine a location, another like communication function, or any combination thereof. Communications may be implemented in according to one or more communication protocols and/or standards, such as IEEE 802.11, CDMA, WCDMA, GSM, LTE, NR, UMTS, WiMax, Ethernet, TCP/IP, SONET, ATM, QUIC, HTTP, and so forth.

Although the client and server computing devices described herein may include the illustrated combination of hardware components, other embodiments may comprise client and/or server computing devices with different combinations of components. It is to be understood that these client and/or server computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the client and/or server computing device, and/or performing one or more operations based on the obtained information or converted information, and as a result of said processing making a determination. Moreover, while components are depicted as single boxes located within a larger box, or nested within multiple boxes, in practice, client and/or server computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the client and/or server computing device, but are enjoyed by the client and/or server computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A computer-implemented method performed by a client computing device for decentralized learning based on local learning at the client computing device, the method comprising:
training a local machine learning (ML) model based on an activation function using a local parameter set and a reference parameter set to obtain a setting for respective local parameters in the local parameter set that minimizes a training loss wherein the activation function preserves agreements and discourages disagreements between the local parameter set and the reference parameter set;
sending the trained local ML model to a server computing device, the trained local ML model comprising the settings of the respective local parameters; and
receiving, from the server computing device, a global ML model that meets a convergence criterion, wherein the global ML model comprises a global parameter set comprising an aggregation of the settings of the respective local parameters from the client computing device and the settings of respective local parameters from at least one additional client computing device.

2. (canceled)

3. The method of claim 1, wherein the training loss comprises a loss defined between a first output response of the local ML model and a second output response of the local ML model comprising the activation function.

4. The method of claim 1, wherein the training comprises passing the local parameter set through the activation function to preserve agreements and to penalize disagreements between the local parameter set and the reference parameter set.

5-6. (canceled)

7. The method of claim 1, wherein the training, the sending, and the receiving comprise a first portion of a round of communication between the client computing device and the server computing device, and
the convergence criterion comprises:
(i) a change in a value of respective global parameters from the global parameter set in successive rounds that is less than a threshold value,
(ii) meeting a specified number of rounds, and/or
(iii) a combination of the change in the value and the meeting the specified number of rounds.

8. The method of claim 1, further comprising:
receiving the global parameter set from the server computing device;
initializing a plurality of contrastive layers in the local ML model based on setting the reference parameter set and initializing the local parameter set with the global parameter set; and
constructing the plurality of contrastive layers.

9. The method of claim 1, wherein the local ML model comprises a neural network comprising a plurality of layers, a respective layer comprises the local parameter set, and a respective local parameter in the local parameter set comprise a weight matrix and a bias vector.

10. The method of claim 9, wherein the constructing comprises:
multiplication, for a respective layer of the neural network, of the weight matrix of a respective local parameter with the activation function, the bias vector of the respective local parameter with the activation function, the weight matric of a respective reference parameter with the activation function, and the bias vector of the respective reference parameter with the activation function.

11. The method of claim 9, wherein the activation function is included in at least one of each of the plurality of layers of the neural network, or selected layers from the plurality of layers of the neural network.

12. The method of claim 9, wherein
the activation function comprises a plurality of activation functions comprising; (i) the plurality of activation functions having a functional form that is the same, of and/or (ii) at least one of the plurality of activation functions having a functional form that different than a functional form of the remaining of the plurality of activation functions, and
wherein at least two layers from the plurality of layers of the neural network respectively include at least: (i) the plurality of activation functions having the functional form that is the same and/or (ii) a first activation function of a first layer that has a functional form that is different than a functional form of a second activation function of a second layer.

13. (canceled)

14. The method of claim 1, wherein the converged global ML model is applied to perform tasks comprising to obtain key performance indicators in at least one of a telecommunications network or to classify image data.

15-16. (canceled)

17. A computer-implemented method performed by a server computing device for decentralized learning based on local learning at a plurality of client computing devices, the method comprising:
receiving a respective trained local machine learning (ML) model from respective client computing devices in the plurality of client computing devices, wherein the respective trained local ML model comprises a local ML model trained based on an activation function using a local parameter set and a reference parameter set to obtain a setting for respective local parameters in the local parameter set that minimizes a training loss wherein the activation function preserves agreements and discourages disagreements between the local parameter set and the reference parameter set;
aggregating the settings of the respective local parameters from the respective client computing devices to obtain a global parameter set; and
sending, to the respective client computing devices, a global ML model comprising the global parameter set that meets a convergence criterion.

18. (canceled)

19. The method of claim 17, wherein the receiving, the aggregating, and the sending comprise a second portion of a round of communication between the client computing device and the server computing device, and the convergence criterion comprises at least one of a change in a value of respective global parameters from the global parameter set in successive rounds that is less than a threshold value, meeting a specified number of rounds, and a combination of the change in the value and the meeting the specified number of rounds.

20. The method of claim 17, wherein the training loss comprises a loss defined between a first output response of the local ML model and a second output response of the local ML model comprising the activation function.

21. The method of claim 17, wherein training of the trained local ML model comprises passing the local parameter set through the activation function to preserve agreements and to penalize disagreements between the local parameter set and the reference parameter set.

22-23. (canceled)

24. The method of claim 17, further comprising:
sending the global parameter set to the respective client computing devices.

25. The method of claim 17, wherein the local ML model comprises a neural network comprising a plurality of layers, a respective layer comprises the local parameter set, and the respective local parameters in the local parameter set comprise a weight matrix and a bias vector.

26. The method of claim 17, wherein the activation function is included in at least one of (i) each of the plurality of layers of the neural network, (ii) or selected layers from the plurality of layers of the neural network.

27. The method of claim 25, wherein
the activation function comprises a plurality of activation functions comprising: (i) the plurality of activation functions having a functional form that is the same and/or (ii) at least one of the plurality of activation functions having a functional form that different than a functional form of the remaining of the plurality of activation functions, and
at least two layers from the plurality of layers of the neural network respectively include at least: (i) the plurality of activation functions having the functional form that is the same and/or (ii) a first activation function of a first layer that has a functional form that is different than a functional form of a second activation function of a second layer.

28. The method of claim 17, wherein the converged global ML model is applied to perform tasks comprising to obtain key performance indicators in at least one of a telecommunications network or to classify image data.

29. (canceled)
